(19) United States
(12) Patent Application Publication
(10) Pub. No.: US 2014/0006005 A1
(43) Pub. Date: Jan. 2, 2014

(54) INPUT SUPPORT APPARATUS, INPUT SUPPORT METHOD, AND STORAGE MEDIUM CONTAINING INPUT SUPPORT PROGRAM

(71) Applicant: CASIO COMPUTER CO., LTD., Tokyo (JP)

(72) Inventor: Takuya HASUNUMA, Tokyo (JP)

(21) Appl. No.: 13/928,239

(22) Filed: Jun. 26, 2013

(30) Foreign Application Priority Data
Jun. 29, 2012 (JP) 2012-146312

(51) Int. Cl. G06F 17/28

(52) U.S. Cl. CPC G06F 17/289
USPC 704/2

(57) ABSTRACT

An input support apparatus includes an example sentence acquiring unit which acquires example sentence data including a plurality of example sentences for each theme; a keyword input unit which inputs a keyword according to user operations; a theme finding unit which finds a theme of an example sentence including the keyword among the example sentences included in the example sentence data; a text input unit which inputs a text according to user operations; and a correspondence example sentence display control unit which extracts one or more example sentences corresponding to the found theme and matching the inputted text from the example sentences for each theme included in the example sentence data, and which controls display of a list of the extracted example sentences.

### BACKGROUND OF THE INVENTION

1. Field of the Invention

The present invention relates to an apparatus and a method for input support which are used for the input of a text on a specific theme by a user and a storage medium containing an input support program.

2. Description of Related Art

Conventional apparatuses, such as tablet personal computers, have a function to support the input of a sentence in a foreign language. For example, a certain word is inputted thereto to then search for example sentences including words relevant to the inputted word and display the example sentences as candidates (for example, refer to Japanese Unexamined Patent Application Publication No. 2009-59290). In another example, a scene of conversation is specified to then display a list of conversational sentences corresponding to the scene (for example, refer to Japanese Unexamined Patent Application Publication No. 2000-137710).

Unfortunately, conventional techniques are inconvenient for a user to create and input a sentence.

For example, the technique disclosed in Japanese Unexamined Patent Application Publication No. 2009-59290 involves search and display of example sentences including words relevant to the inputted words upon inputting several words. As a result, the example sentences are excessively refined. This may cause non-display of matched example sentences. The technique disclosed in Japanese Unexamined Patent Application Publication No. 2000-137710 displays a list of conversation sentences corresponding to a specified scene. This technique has disadvantages of not refining the example sentences sufficiently, which makes it difficult to search for an intended example sentence.

### SUMMARY OF THE INVENTION

It is an object of the present invention to provide an apparatus and a method for input support which are more convenient to create and input a sentence.

According to an aspect of the present invention, there is provided an input support apparatus including: an example sentence acquiring unit which acquires example sentence data including a plurality of example sentences for each theme; a keyword input unit which inputs a keyword according to user operations; a theme finding unit which finds a theme of an example sentence including the keyword among the example sentences included in the example sentence data; a text input unit which inputs a text according to user operations; and a correspondence example sentence display control unit which extracts one or more example sentences corresponding to the theme found by the theme finding unit and matching the text inputted by the text input unit from the example sentences for each theme included in the example sentence data, and which controls display of a list of the extracted example sentences.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 is a block diagram illustrating a functional configuration of a display terminal;

FIG. 2 illustrates a table of example sentences classified by themes;

FIGS. 3 and 4 are flow charts illustrating the flow of an input support process;

FIG. 5 is a flowchart illustrating the flow of a personal name replacing process;

FIGS. 6A to 6D illustrate the content appearing on a display;

FIGS. 7A to 7D illustrate the content appearing on the display; and

FIGS. 8A to 8E illustrate the content appearing on the display.

### DESCRIPTION OF THE PREFERRED EMBODIMENTS

An embodiment according to the present invention will now be described in detail with reference to the accompanying drawings. The scope of the present invention should however not be limited to examples illustrated in these drawings.

### [Configuration]

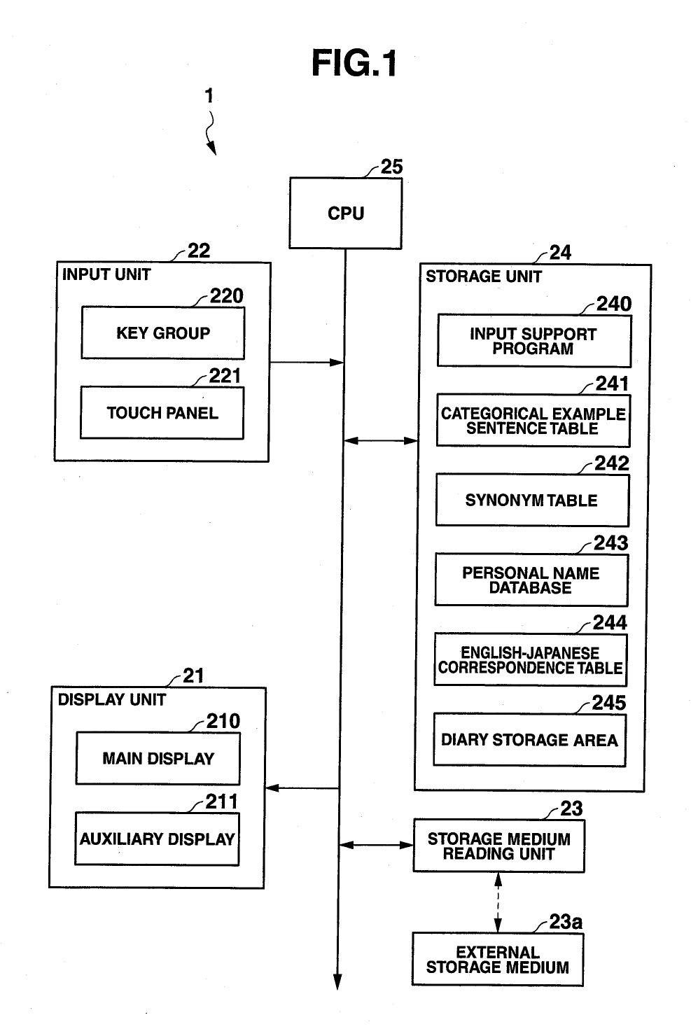

FIG. 1 is a schematic block diagram illustrating a functional configuration of a display terminal 1 according to the present embodiment.

As illustrated in FIG. 1, the display terminal 1 in the present embodiment includes, for example, a display unit 21, an input unit 22, a storage medium reading unit 23, a storage unit 24, and a CPU 25.

The display unit 21 includes a main display 210 and an auxiliary display 211, and displays various types of information on the main display 210 or the auxiliary display 211 on the basis of display signals sent from the CPU 25. The main display 210 and the auxiliary display 211 in the present embodiment are integrated with a touch panel 221 and can receive a touch operation by a user.

The input unit 22 includes a key group 220 and the touch panel 221 and outputs a signal corresponding to a pressed key or a touched position on the touch panel 221 to the CPU 25.

The storage medium reading unit 23 reads information from an external storage medium 23a such as an SD card and records information on the external storage medium 23a.

The storage unit 24 stores programs and data for performing various functions of the display terminal 1 and serves as a work area for the CPU 25. In the present embodiment, the storage unit 24 stores, for example, an input support program 240, a table 241 of example sentences classified by themes (hereinafter referred to as categorical example sentence table 241), a synonym table 242, a personal name database 243, an English-Japanese correspondence table 244, and a diary storage area 245.

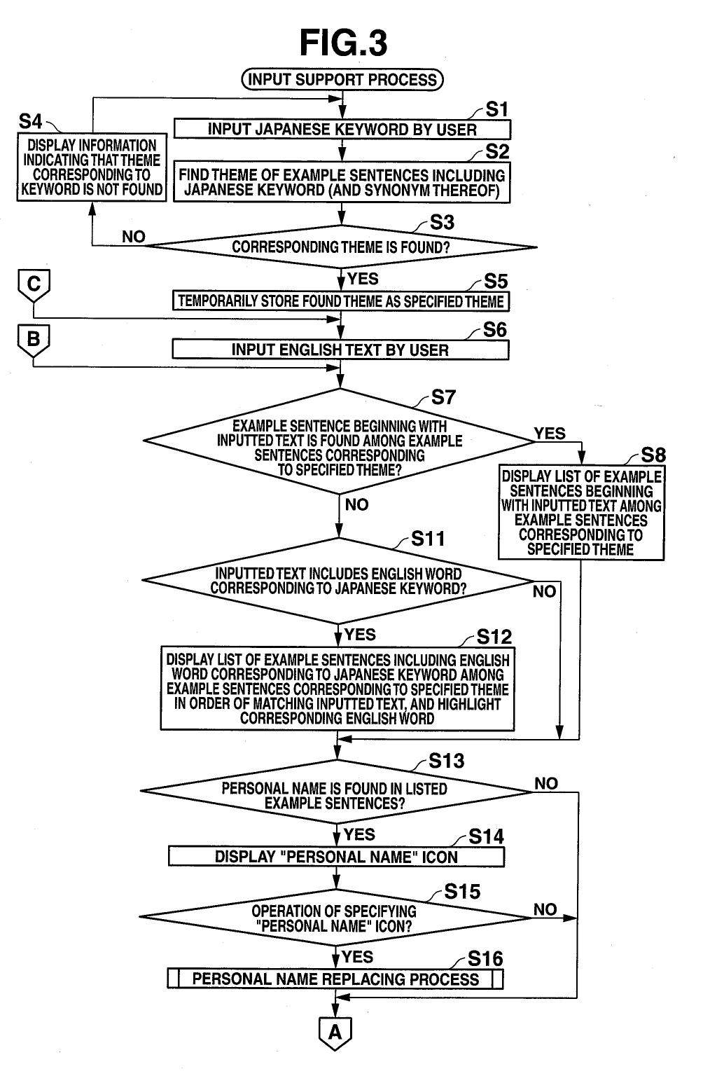

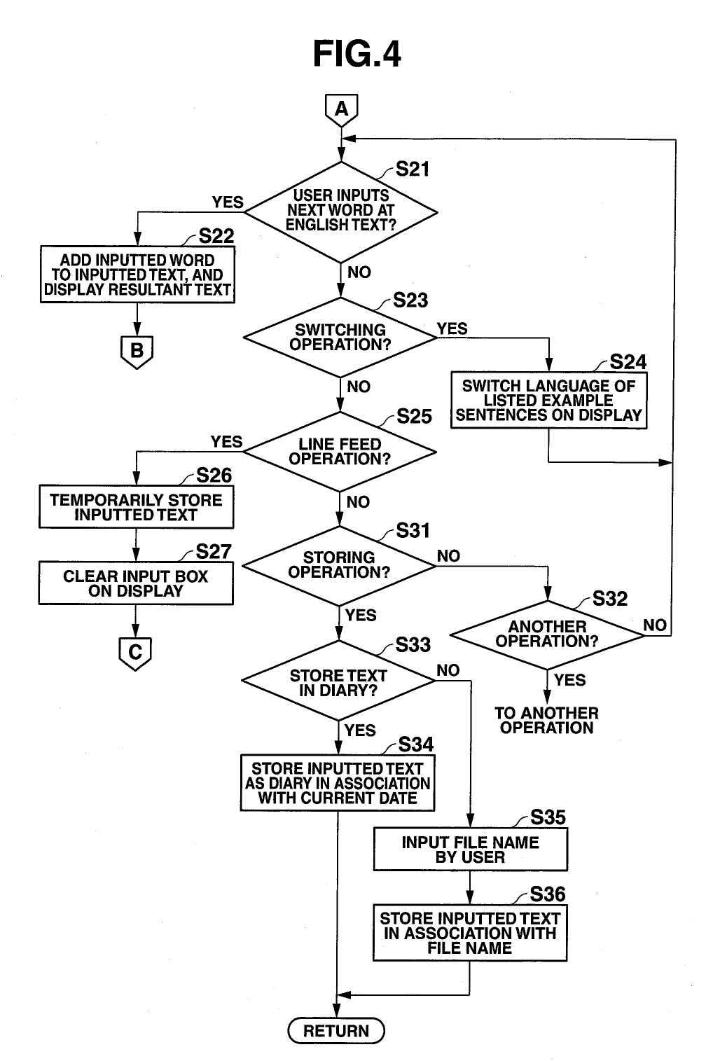

The input support program 240 causes the CPU 25 to perform an input support process described below (refer to FIGS. 3 and 4).

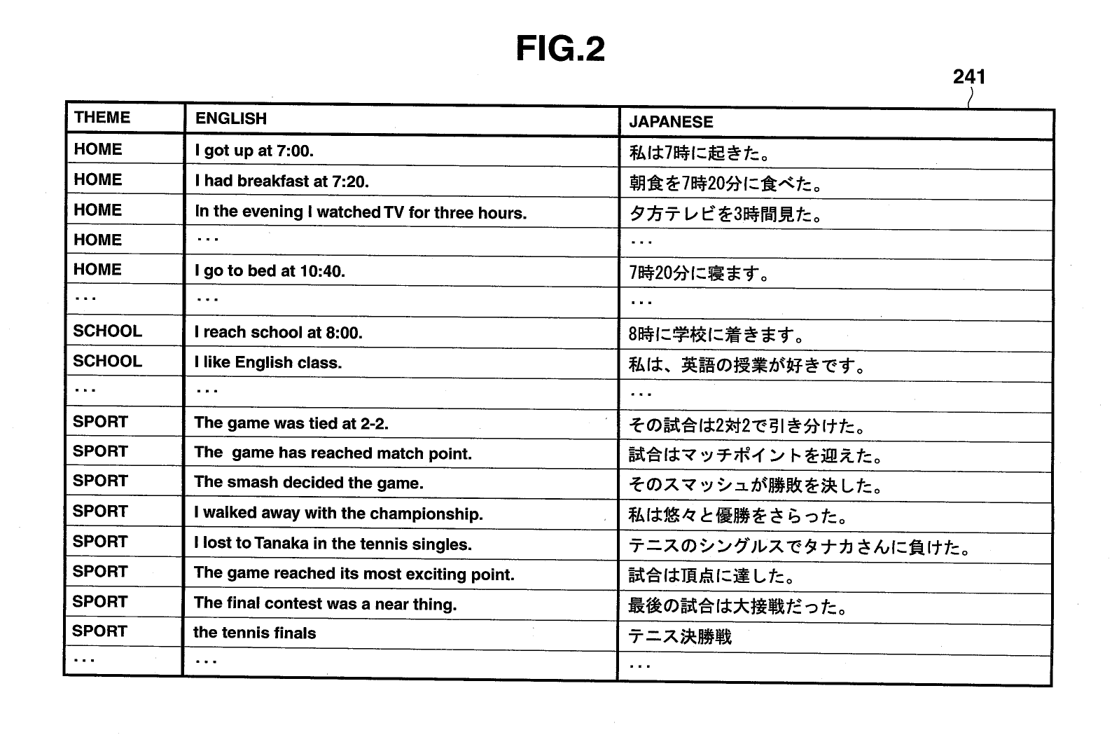

The categorical example sentence table 241 stores example sentence data including a plurality of example sentences for each theme. In the present embodiment, the categorical example sentence table 241 stores example sentence data including English example sentences associated with Japanese example sentences which are the translations of the respective English example sentences, as illustrated in FIG. 2. This example sentence data is acquired by the input by a user or download from an external source.

The synonym table 242 stores synonym data including words each of which is as sociated with a synonym (s) of the word. This synonym data is acquired by the input by a user or download from an external source.

The personal name database 243 stores a plurality of personal names.

The English-Japanese correspondence table 244 stores a plurality of English words associated with Japanese words which are the translations of the respective English words.

The diary storage area 245 stores a text of a diary inputted by a user in association with the date.

The CPU 25 comprehensively controls individual units of the display terminal 1. More specifically, the CPU 25 expands a specified program among system programs and various application programs stored in the storage unit 24, and executes various processes in collaboration with the expanded program.

### [Input Support Process]

The input support process performed by the display terminal 1 will now be described with reference to the accompanying drawings.

FIGS. 3 and 4 are flow charts for explaining the operation of the input support process. When a user inputs an execution command to perform the input support process through the input unit 22, the input support program 240 is read from the storage unit 24 and adequately expanded. The input support process is then executed through collaboration of the input support program 240 with the CPU 25.

In the input support process as illustrated in FIG. 3, the CPU 25 inputs a Japanese keyword according to user operations (Step S1). In Step S1, a user can input a plurality of keywords.

The CPU 25 then refers to the categorical example sentence table 241 to find the theme of example sentences including the Japanese keyword among the Japanese example sentences stored in the categorical example sentence table 241 (Step S2). At this time, the CPU 25 also sets synonyms associated with the Japanese keyword on the basis of the synonym data in the synonym table 242, as Japanese keyword-relevant words. The CPU 25 then refers to the categorical example sentence table 241 to find the theme of example sentences including the Japanese keyword-relevant words among the Japanese example sentences stored in the categorical example sentence table 241.

The CPU 25 then determines whether the theme is found (Step S3). If the theme is not found (Step S3; No), the CPU 25 displays information indicating that the theme of the example sentences corresponding to the Japanese keyword is not found on the main display 210 (Step S4), and the process goes to Step S1 described above.

If the theme is found in step S3 (Step S3; Yes), the CPU 25 temporarily stores the found theme as a specified theme in the storage unit 24 (Step S5).

In step S6, the CPU 25 inputs an English text from its head according to user operations.

The CPU 25 then determines whether a plurality of example sentences for each theme included in the example sentence data in the categorical example sentence table 241 include English example sentences corresponding to the specified theme and beginning with the inputted English text (Step S7).

If the plurality of example sentences include one or more English example sentences corresponding to the specified theme and beginning with the inputted English text in Step S7 (Step S7; Yes), the CPU 25 reads (extracts) the corresponding example sentence (s), and displays a list of the resultant example sentence (s) on the main display 210 (Step S8), and the process goes to Step S13 described below.

If one or more English example sentences corresponding to the specified theme and beginning with the inputted English text are not included in Step S7 (Step S7; No), the CPU 25 finds an English word which is the translation of the Japanese keyword (hereinafter referred to as keyword correspondence English word) and finds English words which are the translations of the Japanese keyword-relevant words (hereinafter referred to as keyword-relevant word correspondence English words), from the English-Japanese correspondence table 244. The CPU 25 then determines whether the inputted English text includes any of the keyword correspondence English word and the keyword-relevant word correspondence English words (Step S11). If the inputted English text does not include such words (Step S11; No), the process of the CPU 25 goes to Step S13 described below.

If the inputted English text includes any of the keyword correspondence English word and the keyword-relevant word correspondence English words in Step S11 (Step S11; Yes), the CPU 25 reads (extracts) example sentences including any of the keyword correspondence English word and the keyword-relevant word correspondence English words from the English example sentences corresponding to the specified theme in the categorical example sentence table 241, and displays a list of the read (extracted) example sentences on the main display 210 in the order of matching with the inputted English text (Step S12). At this time, the CPU 25 also highlights the keyword correspondence English word and the keyword-relevant word correspondence English words in the displayed list of the example sentences.

Next, the CPU 25 determines whether a personal name is included in the displayed list of the example sentences (Step S13). If it is not included therein (Step S13; No), the process of the CPU 25 goes to Step S21 described below, as illustrated in FIG. 4. In the present embodiment, a personal name is found by searching the displayed list of example sentences for each name included in the personal name database 243. Alternatively, the personal name may be found by searching for a character string such as “Mr.” and “Mrs.” connectable to a personal name.

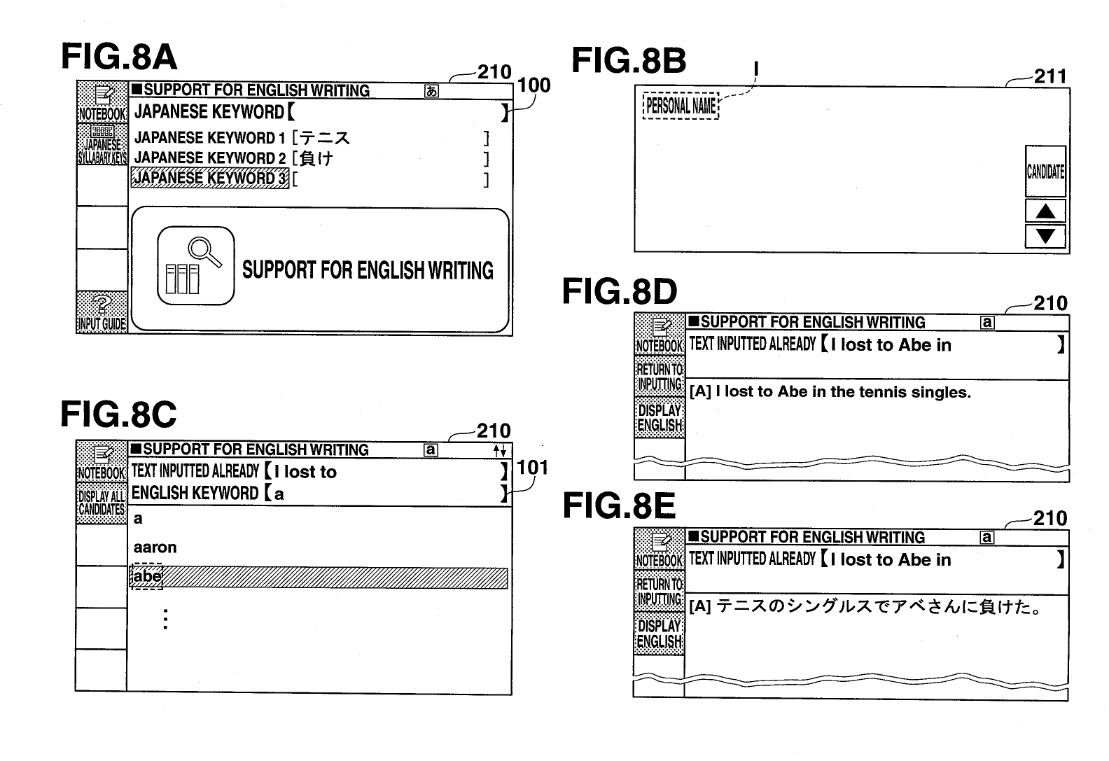

As illustrated in FIG. 3, if a personal name is included in the example sentences in Step S13 (Step S13; Yes), the CPU 25 displays a personal name icon I (refer to FIG. 8B) on the auxiliary display 211 (Step S14).

Next, the CPU 25 determines whether a touch operation is performed on the personal name icon I (Step S15). If it is not performed (Step S15; No), the process of the CPU 25 goes to Step S21 described below, as illustrated in FIG. 4.

If the touch operation is performed in Step S15 (Step S15; Yes), the CPU 25 performs a personal name replacing process as illustrated in FIG. 3 (Step S16).

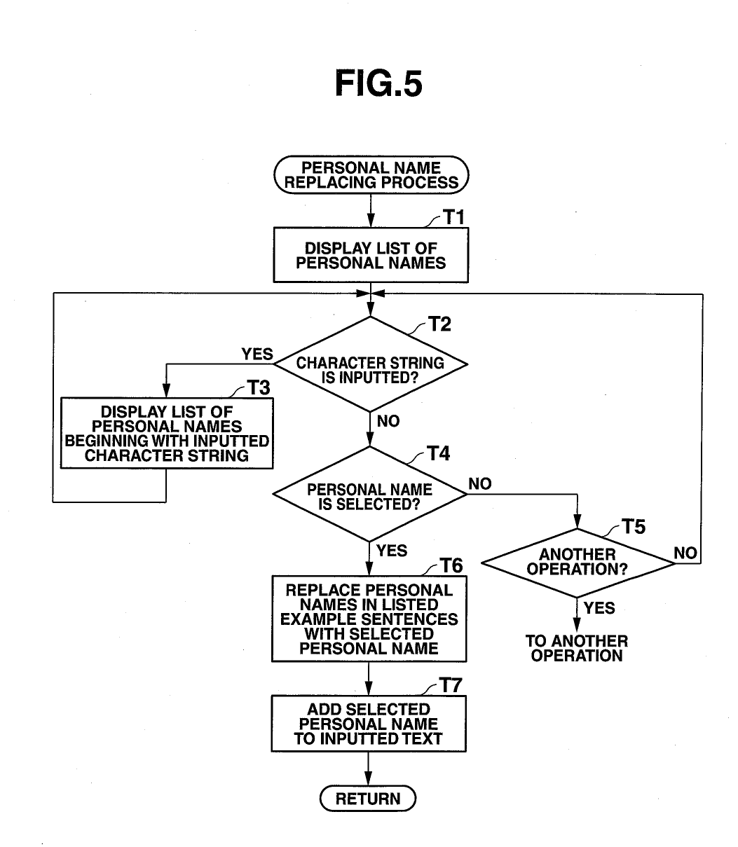

Specifically, in the personal name replacing process as illustrated in FIG. 5, the CPU 25 displays a list of personal names in the personal name database 243 in the order from the head on the main display 210 (Step T1). The CPU 25 then displays an input box for a personal name (hereinafter referred to as personal name input box 101 (refer to FIG. 8C)) on the main display 210, and determines whether the operation of inputting a character string in the personal name input box 101 is performed (Step T2).

If the operation of inputting the character string is performed in Step T2 (Step T2; Yes), the CPU 25 searches the personal name database 243 for personal names beginning with the inputted character string, and displays a list of the resultant personal names on the main display 210 (Step T3), and then the process goes to Step T2.

If the operation of inputting the character string is not performed in Step T2 (Step T2; No), the CPU 25 determines whether the operation of selecting a displayed personal name is performed (Step T4). The selected personal name is different from the personal names included in the displayed list of the example sentences.

If the operation of selecting the personal name is not performed in Step T4 (Step T4; No), the CPU 25 determines whether another operation is performed (Step T5).

If another operation is performed in Step T5 (Step T5; Yes), the process of the CPU 25 goes to the process for the operation; otherwise (Step T5; No), the process goes to Step T2 described above.

If the operation of selecting the personal name is performed in Step T4 (Step T4; Yes), the CPU 25 automatically inputs the selected personal name into the personal name input box 101 up to the end of the name, replaces the personal names in the displayed list of the example sentences with the selected personal name, and displays the personal names after the replacement (Step T6).

Next, the CPU 25 adds the selected personal name into the inputted English text (Step T7) and finishes the personal name replacing process.

The CPU 25 then determines whether the operation of inputting a next word at the end of the inputted English text is performed, as illustrated in FIG. 4 (Step S21).

If the operation of inputting the next word at the end of the inputted English text is performed in Step S21 (Step S21; Yes), the CPU 25 adds the inputted word to the inputted English text, and displays the resultant text (Step S22), and then the process goes to Step S7 described above, as illustrated in FIG. 3.

Otherwise (Step S21; No), the CPU 25 determines whether the operation of switching the language on the display is performed, as illustrated in FIG. 4 (Step S23).

If the operation of switching the language on the display is performed in Step S23 (Step S23; Yes), the CPU 25 switches the language of the displayed list of example sentences between English and Japanese, and updates the content on the main display 210 (Step S24), and then the process goes to Step S21 described above.

If the operation of switching the language on the display is not performed in Step S23 (Step S23; No), the CPU 25 determines whether the operation of line feed is performed (Step S25).

If the operation of line feed is performed in Step S25 (Step S25; Yes), the CPU 25 temporarily stores the inputted English text in the storage unit 24 (Step S26), and clears the input box for the inputted English text (Step S27), and then the process goes to Step S6 described above, as illustrated in FIG. 3.

If the operation of line feed is not performed in Step S25 (Step S25; No), the CPU 25 determines whether the operation of storing the inputted English text is performed, as illustrated in FIG. 4 (Step S31).

If the operation of storing the inputted English text is not performed in Step S31 (Step S31; No), the CPU 25 determines whether another operation is performed (Step S32).

If another operation is performed in Step S32 (Step S32; Yes), the process of the CPU 25 goes to a process for the operation; otherwise (Step S32; No), the process of the CPU 25 goes to Step S21 described above.

If the operation of storing the inputted English text is performed in Step S31 (Step S31; Yes), the CPU 25 determines whether the operation of storing the text in the diary storage area 245 is performed (Step S33).

If the operation of storing the text in the diary storage area 245 is performed in Step S33 (Step S33; Yes), the CPU 25 stores the inputted English text in association with the current date in the diary storage area 245 (Step S34), and finishes the input support process. If there is an inputted English text which has temporarily been stored in Step S26 described above, the CPU 25 stores the temporarily stored text together with the English text in the diary storage area 245 in Step S34.

If the operation of storing the text in the diary storage area 245 is not performed in Step S33 (Step S33; No), the CPU 25 inputs a file name according to user operations (Step S35). The CPU 25 then stores the inputted English text in association with the file name in the storage unit 24 (Step S36) and ends the input support process. If there is an inputted English text which has temporarily been stored in Step S26 described above, the CPU 25 stores the temporarily stored text together with the English text in the storage unit 24 in Step S36.

### OPERATION EXAMPLES

The operation of the display terminal 1 will now be described in detail with reference to the accompanying drawings.

### Operation Example 1

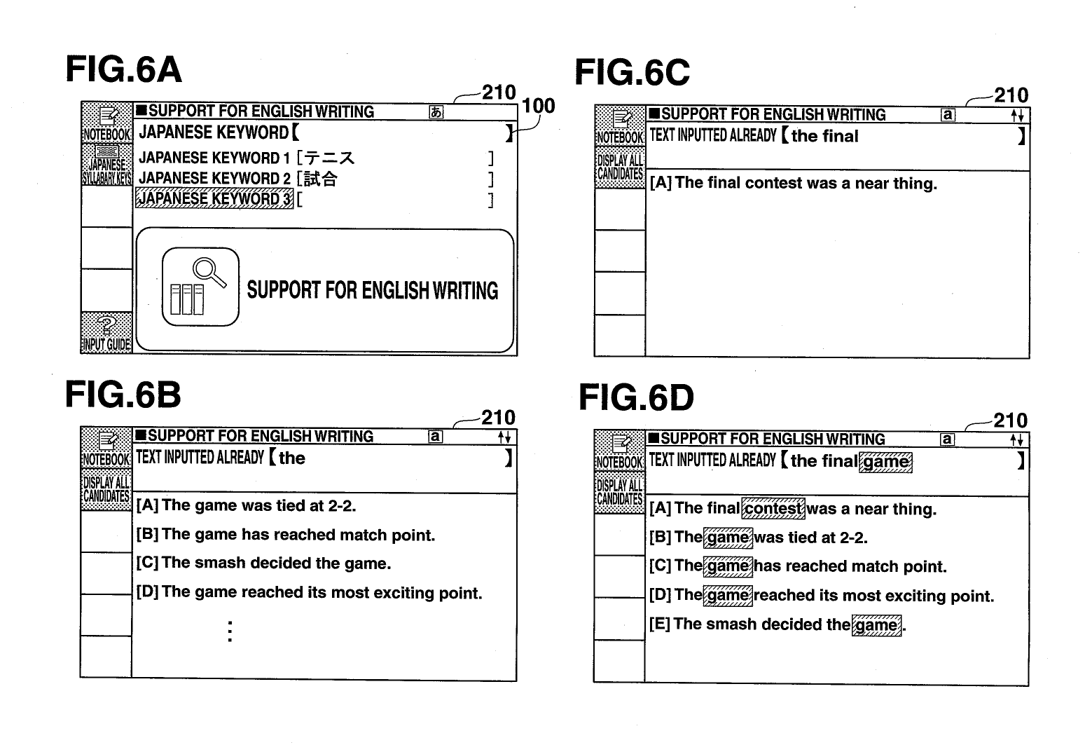

A user inputs Japanese keywords “ [symbol] ” (“tenisu”, which indicates tennis in English) and “ [symbol] ” (“shiai”, which indicates game in English) as illustrated in FIG. 6A (Step S1). A theme “sport” of example sentences including the Japanese keywords “ [symbol] ” and “ [symbol] ” is then found among the Japanese example sentences stored in the categorical example sentence table 241 (Step S2). At this time, Japanese keyword-relevant words “ [symbol] ” (“macchi”, which indicates match in English), “ [symbol] ” (“kontesuto”, which indicates contest in English), . . . corresponding to the Japanese keyword “ [symbol] ” are also found from the synonym table 242. A theme “sport” of example sentences including the Japanese keyword “ [symbol] ” and the Japanese keyword-relevant words “ [symbol] ”, “ [symbol] ”, are then found among the Japanese example sentences stored in the categorical example sentence table 241. In this operation example, a keyword input box 100 is displayed on the main display 210 when a Japanese keyword is inputted. If a Japanese keyword is inputted into the keyword input box 100 and then determination operation is performed, the inputted keyword is moved to and displayed in a field “Japanese keyword 1” or “Japanese keyword 2”.

Next, the theme “sport” is determined to be found (Step S3; Yes) and then the found theme “sport” is temporarily stored as a specified theme in the storage unit 24 (Step S5).

Next, when the user inputs a word “the” at the head of an English text (Step S6), it is determined that the example sentences in the categorical example sentence table 241 include English example sentences corresponding to the specified theme “sport” and beginning with the inputted English text “the”, as illustrated in FIG. 6B (Step S7; Yes). The corresponding example sentences “The game was tied . . . ”, “The game has reached . . . ”, . . . are read to display a list of the read sentences on the main display 210 as illustrated in FIG. 6B (Step S8).

Next, it is determined that a personal name is not included in the displayed list of the example sentences (Step S13; No).

If the user inputs the next word “final” at the end of the inputted English text with reference to the displayed list of example sentences as illustrated in FIG. 6C (Step S21; Yes), the inputted word “final” is added to and displayed together with the inputted English text “the” (Step S22). Then, it is determined that the example sentences in the categorical example sentence table 241 include an English example sentence corresponding to the specified theme “sport” and beginning with the inputted English text “the final” (Step S7; Yes). The corresponding example sentence “The final contest was . . . ” is read to be listed on the main display 210 (Step S8).

Then, it is determined that a personal name is not included in the displayed list of the example sentences (Step S13; No).

Next, if the user inputs the next word “game” at the end of the inputted English text with reference to the displayed list of example sentences as illustrated in FIG. 6D (Step S21; Yes), the inputted word “game” is added to and displayed together with the inputted English text “the final” (Step S22). After that, it is determined that the example sentences in the categorical example sentence table 241 do not include an English example sentence corresponding to the specified theme “sport” and beginning with the inputted English text “the final game” (Step S7; No).

The inputted English text “the final game” is then determined to include the keyword correspondence English word “game” (Step S11; Yes). Example sentences including any of the keyword correspondence English words “tennis” and “game” and the keyword-relevant word correspondence English words “match”, “contest” . . . are then read (extracted) from the English example sentences corresponding to the specified theme “sport” in the categorical example sentence table 241. A list of the read (extracted) example sentences are then displayed on the main display 210 in the order of matching with the inputted English text “the final game” (Step S12). At this time, the keyword correspondence English words “tennis” and “game” and the keyword-relevant word correspondence English words “match”, “contest” . . . are highlighted in the displayed list of the example sentences by, for example, marking or shading.

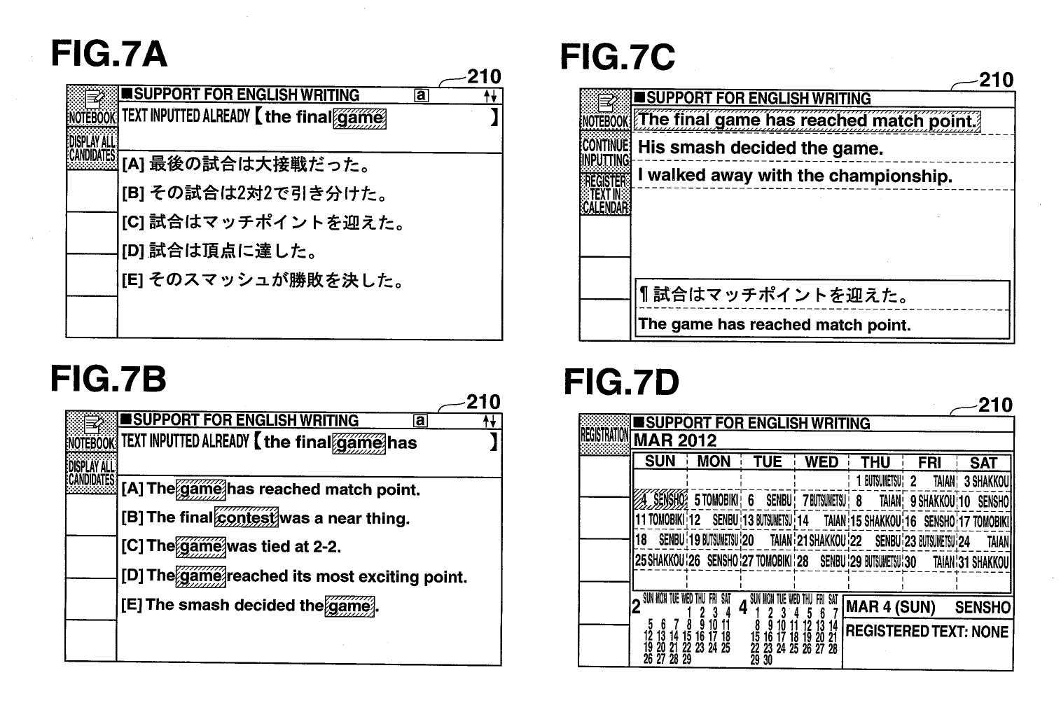

Next, it is determined that a personal name is not included in the displayed list of the example sentences (Step S13; No). After that, if the user performs the operation of switching the language on the display (Step S23; Yes), the language of the displayed list of example sentences is switched from English to Japanese and the content on the main display 210 is updated, as illustrated in FIG. 7A (Step S24).

If the user does not perform the operation of switching the language on the display but inputs the next word “has” at the end of the inputted English text “the final game” with reference to the displayed list of example sentences as illustrated in FIG. 7B (Step S21; Yes), the inputted word “has” is added to and displayed together with the inputted English text “the final game” (Step S22). After that, it is determined that the example sentences in the categorical example sentence table 241 do not include an English example sentence corresponding to the specified theme “sport” and beginning with the inputted English text “the final game has” (Step S7; No).

The inputted English text “the final game has” is then determined to include the keyword correspondence English word “game” (Step S11; Yes). Example sentences including any of the keyword correspondence English words “tennis” and “game” and the keyword-relevant word correspondence English words “match”, “contest” . . . are then read from the English example sentences corresponding to the specified theme “sport” in the categorical example sentence table 241. The resultant example sentences are then listed on the main display 210 in the order of matching with the inputted English text “the final game has” (Step S12). At this time, the keyword correspondence English words “tennis” and “game” and the keyword-relevant word correspondence English words “match”, “contest” . . . are highlighted in the displayed list of the example sentences.

In the same way after that, if the user inputs the next words “reached”, “match”, and “point” at the end of the inputted English text with reference to the displayed list of example sentences (Step S21; Yes), the inputted words “reached”, “match”, and “point” are added to and displayed together with the inputted English text “the final game has” (Step S22).

Next, if the user performs the operation of storing the inputted English text (Step S31; Yes), this operation example displays an example sentence “The game has reached match point.” (refer to the example sentence in the uppermost line of FIG. 7B) that is the most matched with the inputted English text “the final game has reached match point.” created this time among the displayed list of example sentences as referential example sentences for the created inputted English text as illustrated in FIG. 7C, while displaying a list of the inputted English texts which have been created by the current time.

If the user performs the operation of storing the texts in the diary storage area 245 (Step S33; Yes), the inputted English texts which have been created by the current time are associated with the current date “Mar. 4, 2012” and stored in the diary storage area 245, as illustrated in FIG. 7D (Step S34).

### Operation Example 2

A user inputs Japanese keywords “ [symbol] ” (“tenisu”, which indicates tennis in English) and “ [symbol] ” (“make”, which indicates defeat in English) as illustrated in FIG. 8A (Step S1). A theme “sport” of example sentences including the Japanese keywords “ [symbol] ” and “ [symbol] ” is then found among the Japanese example sentences stored in the categorical example sentence table 241 (Step S2).

Next, the theme “sport” is determined to be found (Step S3; Yes) and then the found theme “sport” is temporarily stored as a specified theme in the storage unit 24 (Step S5).

Similarly to the operation example 1, if the user then inputs words “I”, “lost”, and “to” as the inputted English text (Steps S6 and S21; Yes), the inputted words “I”, “lost”, and “to” are added to and displayed together with the inputted English text (Step S22). Then, it is determined that the example sentences in the categorical example sentence table 241 include an English example sentence corresponding to the specified theme “sport” and beginning with the inputted English text “I lost to” (Step S7; Yes). The corresponding example sentence “I lost to Tanaka in the . . . ” is read to be listed on the main display 210 (Step S8).

Next, a personal name “Tanaka” is determined to be included in the displayed list of the example sentences (Step S13; Yes). A personal name icon I is then displayed on the auxiliary display 211, as illustrated in FIG. 8B (Step S14).

If the user then performs the touch operation on the personal name icon I (Step S15; Yes), the main display 210 displays the personal name input box 101 and a list of personal names in the personal name data base 243 in the order from the head (Step T1), as illustrated in FIG. 8C.

If the user then inputs a character string “a” into the personal name input box 101 (Step T2; Yes), the personal name data base 243 is searched for personal names beginning with the inputted character string “a”, and a list of the resultant personal names is displayed on the main display 210 (Step T3).

If the user then performs the operation of selecting a personal name “Abe” (Step T4; Yes), the personal name “Tanaka” in the displayed list of the example sentences is replaced with the selected personal name “Abe”, and the replaced personal name is displayed, as illustrated in FIG. 8D (Step T6).

The selected personal name “Abe” is then added to the inputted English text “I lost to” (Step T7).

Next, if the user inputs the next word “in” at the end of the inputted English text with reference to the displayed list of example sentences (Step S21; Yes), the inputted word “in” is added to and displayed together with the inputted English text “I lost to Abe” (Step S22). Then, it is determined that the example sentences in the categorical example sentence table 241 include an English example sentence “I lost to Tanaka in” corresponding to the specified theme “sport” and beginning with the inputted English text “I lost to Abe in” (Step S7; Yes). In this case, “Tanaka” and “Abe” are treated as personal names replaceable with each other, i.e., equivalent words, for judgment on the begins-with match. An English example sentence “I lost to Tanaka in . . . ” corresponding to the specified theme “sport” and beginning with the inputted English text “I lost to Abe in” is read to be listed on the main display 210 with the personal name in the example sentence replaced with the personal name “Abe” selected by the user (Step S8).

If the user then performs the operation of switching the language on the display (Step S23; Yes), the language of the displayed list of example sentences is switched from English to Japanese, and the content on the main display 210 is updated, as illustrated in FIG. 8E (Step S24). In this step of this operation example, the personal name “Abe” selected by the user in the example sentence is replaced with “ [symbol] ”, which is in the form of “katakana” (a type of a Japanese syllabary) on the display.

According to the present embodiment, as illustrated in, for example, Steps S1 to S12 in FIG. 3 and FIG. 6, an English text is inputted from its head according to user operations; one or more example sentences corresponding to the specified theme and matching the inputted English text are then read from a plurality of example sentences included in the example sentence data in the categorical example sentence table 241, and a list of the resultant example sentence(s) is displayed; and when the example sentence matching the inputted English text is not found, one or more example sentences corresponding to the specified theme and including the keyword correspondence English word or the keyword-relevant word correspondence English word(s) is read from a plurality of example sentences included in the example sentence data in the categorical example sentence table 241, and a list of the resultant example sentence(s) is displayed. The resultant example sentence(s) (i.e., the example sentence(s) which corresponds to the theme of the keyword and which includes the keyword or the keyword-relevant word) can be used as reference for the input of a text even if the example sentence matching the inputted English text is not found. Unlike conventional techniques, this can prevent non-display of example sentences due to excessive refinement or can avoid a difficulty in searching for an intended example sentence due to insufficient refinement, and thus provide more convenience for creating and inputting a sentence.

As illustrated in, for example, Steps S1 to S12 in FIG. 3 and FIG. 6, a synonym (s) associated with the Japanese keyword based on the synonym data in the synonym table 242 is set as a Japanese keyword-relevant word(s); a theme of example sentences including the Japanese keyword-relevant word(s) is found as the specified theme among the example sentences in the categorical example sentence table 241; and when the inputted text includes an English word(s) which is the translation of the Japanese keyword or the Japanese keyword-relevant word(s), one or more example sentences including the English word(s) are read from the example sentence data corresponding to the specified theme in the categorical example sentence table 241, and a list of the resultant example sentence(s) is displayed in the order of matching with the inputted text. This can ensure display of example sentence (s) useful as reference for the input of a text.

As illustrated in, for example, Step S12 in FIG. 3 and FIG. 6D, the keyword correspondence English word is highlighted in the displayed list of the example sentences. This makes it easier to confirm how the keyword correspondence English word is used in the example sentences. Therefore, a user can easily find example sentences using the keyword correspondence English word in an intended manner and can use the found sentences as reference for the input of a text.

The detailed configuration and detailed operation of each component of the display terminal 1 according to the embodiments can be modified appropriately within the scope which does not deviate from the gist of the present invention.

For example, although the input support apparatus according to the present invention has been described as the display terminal 1, the apparatus to which the present invention is applicable is by no means limited to such a product but the present invention is generally applicable to the electronic devices such as scientific electronic calculators, mobile telephones, personal computers, PDAs (Personal Digital Assistants), and game machines. The input support program 240 according to the present invention may be stored in, for example, a memory card or a CD which is removable from the display terminal 1.

In the above description, a keyword is inputted in Japanese while a text is inputted in English. Alternatively, the keyword and text may be inputted in either one of the languages.

In the above description, the process in Step S2 finds a theme of Japanese example sentences including the Japanese keyword or the Japanese keyword-relevant word(s). Alternatively, the process may find a theme of English example sentences including the keyword correspondence English word or the keyword-relevant word correspondence English word(s). Similarly, the process of Step S12 in the above description reads (extracts) English example sentences including the keyword correspondence English word or the keyword-relevant word correspondence English word(s) from the example sentence data in the categorical example sentence table 241, and displays a list of the read (extracted) example sentences. Alternatively, the process may read (extract) English example sentences corresponding to Japanese example sentences including the Japanese keyword or the Japanese keyword-relevant word(s) from the categorical example sentence table 241, and display a list of the read (extracted) example sentences.

In the above description, the CPU 25 performs the input support process using example sentence data in the categorical example sentence table 241 and synonym data in the synonym table 242 stored in the storage unit 24. Alternatively, the CPU 25 may perform the input support process while appropriately acquiring example sentence data in the categorical example sentence table 241 and synonym data in the synonym table 242 stored in an external apparatus.

The scope of the present invention is not limited to the embodiments described herein, but is claimed in the accompanying claims, and includes the scope of equivalents thereof.

The entire disclosure of Japanese Patent Application No. 2012-146312 filed on Jun. 29, 2012 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An input support apparatus comprising:
an example sentence acquiring unit which acquires example sentence data including a plurality of example sentences for each theme;
a keyword input unit which inputs a keyword according to user operations;
a theme finding unit which finds a theme of an example sentence including the keyword among the example sentences included in the example sentence data;
a text input unit which inputs a text according to user operations; and
a correspondence example sentence display control unit which extracts one or more example sentences corresponding to the theme found by the theme finding unit and matching the text inputted by the text input unit from the example sentences for each theme included in the example sentence data, and which controls display of a list of the extracted example sentences.

2. The input support apparatus according to claim 1, wherein
the correspondence example sentence display control unit includes:
a keyword example sentence display control unit which extracts one or more example sentences corresponding to the theme found by the theme finding unit and including the keyword or a word relevant to the keyword from the example sentences for each theme included in the example sentence data, and which controls display of a list of the extracted example sentences when the example sentence data does not include the example sentences matching the text inputted by the text input unit.

3. The input support apparatus according to claim 2, wherein
the keyword example sentence display control unit includes:
a matching order example sentence display control unit which extracts one or more example sentences corresponding to the theme found by the theme finding unit and including the keyword or the word relevant to the keyword from the example sentences for each theme included in the example sentence data, and which controls display of a list of the extracted example sentences in an order of matching with the text inputted by the text input unit.

4. The input support apparatus according to claim 1, wherein
the correspondence example sentence display control unit extracts one or more example sentences corresponding to the theme found by the theme finding unit and beginning with the text inputted by the text input unit from the example sentences for each theme included in the example sentence data, and which controls display of a list of the extracted example sentences.

5. The input support apparatus according to claim 2, further comprising:
a synonym acquiring unit which acquires synonym data including words each of which is associated with a synonym thereof; and
a keyword-relevant word setting unit which sets a synonym associated with the keyword in the synonym data, as the word relevant to the keyword, wherein
the theme finding unit includes:
a relevant-word theme finding unit which finds a theme of an example sentence including the word relevant to the keyword among the example sentences included in the example sentence data;
the keyword example sentence display control unit includes:
a keyword-relevant word example sentence display control unit which extracts one or more example sentences including the word relevant to the keyword among example sentences corresponding to the theme found by the relevant-word theme finding unit from the example sentences included in the example sentence data, and which controls display of a list of the extracted example sentences in an order of matching with the text inputted by the text input unit when the text includes the keyword or the word relevant to the keyword.

6. The input support apparatus according to claim 5, wherein
the example sentence data includes first example sentences in a first language and second example sentences in a second language for each theme, the second example sentences being translations of the respective first example sentences and being associated with the respective first example sentences;
the keyword input unit inputs the keyword in the first language;
the text input unit inputs the text in the second language;
the keyword example sentence display control unit uses a word obtained by translating the keyword into the second language, as the keyword;
the correspondence example sentence display control unit controls display of a list of the second example sentences in the second language; and
the keyword-relevant word example sentence display control unit uses a word obtained by translating the word relevant to the keyword into the second language, as the word relevant to the keyword.

7. The input support apparatus according to claim 2, wherein
the keyword example sentence display control unit performs control so as to highlight the keyword in the displayed list of the example sentences.

8. The input support apparatus according to claim 1, further comprising:
a personal name determining unit which determines whether a personal name is included in the list of the example sentences displayed by the correspondence example sentence display control unit;
a personal name input unit which inputs, when the personal name determining unit determines that a first personal name is included in the example sentences, a second personal name different from the first personal name according to user operations; and
a personal name replacing display control unit which replaces the first personal name in the example sentences displayed by the correspondence example sentence display control unit, with the second personal name inputted by the personal name input unit, and which controls display of the example sentences after the replacement.

9. An input support method for a computer including an example sentence acquiring unit which acquires example sentence data including a plurality of example sentences for each theme, the method comprising:
inputting a keyword according to user operations;
finding a theme of an example sentence including the keyword among the example sentences included in the example sentence data;
inputting a text according to user operations; and
extracting one or more example sentences corresponding to the found theme and matching the inputted text from the example sentences for each theme included in the example sentence data, and controlling display of a list of the extracted example sentences.

10. Anon-transitory storage medium containing an input support program to be executed by a computer including an example sentence acquiring unit which acquires example sentence data including a plurality of example sentences for each theme, the program making the computer realize functions of:
a keyword input unit which inputs a keyword according to user operations;
a theme finding unit which finds a theme of an example sentence including the keyword among the example sentences included in the example sentence data;
a text input unit which inputs a text according to user operations; and
a correspondence example sentence display control unit which extracts one or more example sentences corresponding to the theme found by the theme finding unit and matching the text inputted by the text input unit from the example sentences for each theme included in the example sentence data, and which controls display of a list of the extracted example sentences.
